(19) United States
(12) Patent Application Publication
(10) Pub. No.: US 2013/0080296 A1
(43) Pub. Date: Mar. 28, 2013

(54) Greenebank

(71) Applicants: Durand Kevin Dickerson, Leavenworth, KS (US); Lawernce Derwood Kenemore, JR., Leavenworth, KS (US)

(72) Inventors: Durand Kevin Dickerson, Leavenworth, KS (US); Lawernce Derwood Kenemore, JR., Leavenworth, KS (US)

(21) Appl. No.: 13/200,431

(22) Filed: Sep. 23, 2011

(51) Int. Cl. G06Q 40/04

(52) U.S. Cl. 705/30; 705/37

(57) ABSTRACT

The invention Greenebank is a specific process that relates to a. system for cross-integrating data from patents #20110038703 FILL-A-BOX, WINROWS (patent pending) and STAT-MEDICAMENT-DISPOSAL™ to create an aggregated record to provide cap and trade credits of a address/location to encourage recycling. Allowing for the address/location to access Greenebank database through a data portal device via the internet to view cap and trade credits, to trade cap and trade credits or to sell cap and trade credits.

### RELATED PATENTS

#20110038703 Fill-A-Box Winrows (patent pending)

### SUMMARY OF THE INVENTION

Embodiments of the present invention relates to a specific process and system and method for administrating a carbon offset cap and trade credit program as an incentive to start and/or increase recycling.

In one embodiment of the present invention a method for administrating a platform for bid, purchase and sale of carbon offset credits under cap and trade having aggregated records of address/location recyclable materials.

In another embodiment of the present invention is a database of recyclable materials collected by address/location, week to week, month to month and year to year available through a data portal device via the internet viewable by the address/location with ability to place carbon offset credits for sale and to redeem funds from the sale of the carbon offset credits.

The details of one or more embodiments of the present invention are set forth in the accompanying drawings and description. Other features and advantages will become apparent from the description and the drawings.

### BRIEF DESCRIPTION OF THE DRAWINGS

The manner in which the above features of the invention can be understood a more detailed description of the embodiments is described below with reference to the figures illustrated in the drawings.

FIGS. 1, 2, 3 and 4 in the drawings, as the detailed description illustrate only examples of the embodiments. As such, the figures and the detailed description are not to be considered limiting and other equally effective examples are possible and likely, wherein:

FIG. 1, shows the barcode on the Fill-A-Box (patent #20110038703) container and the barcode on the Winrows (patent pending) containers.

FIG. 2, shows the weighing of FIG. 1 upon curbside pickup and wireless transmission via internet to address/location file of weight picked up.

FIG. 3, shows upon receiving the Fill-A-Box (patent #20110038703) container and Winrows (patent pending) container at warehouse the weighing and counting of items received and then transmitting that data via internet to the address/location data file.

FIG. 4, sets forth the use of data received from address/location, converting to carbon offset credits, sales of carbon offset credits and crediting address/location with dollar amounts into their account of carbon offset credits.

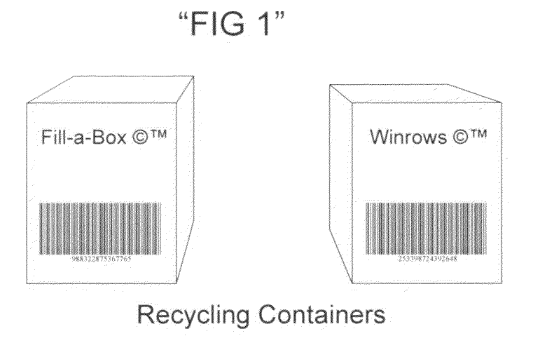

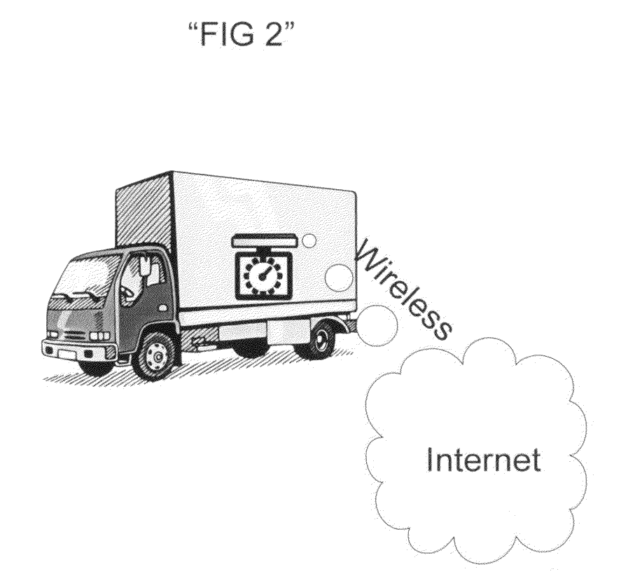

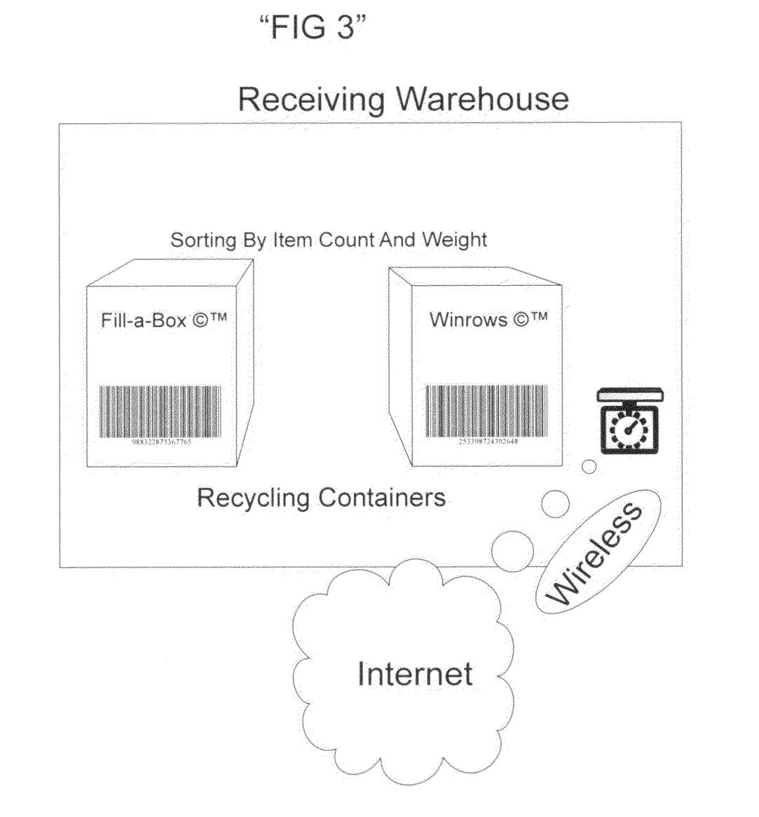

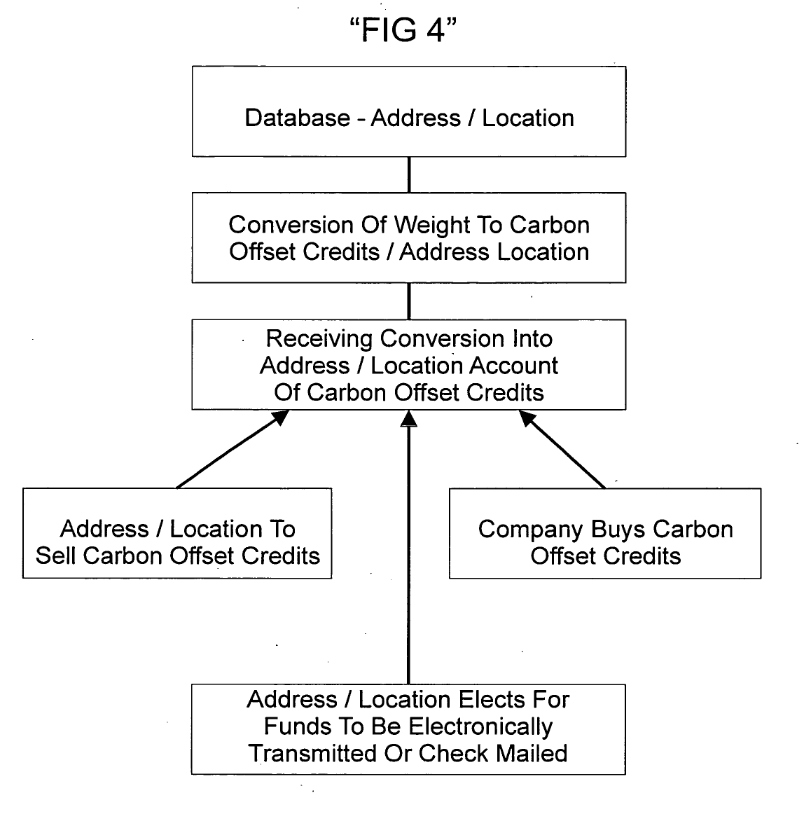

### DESCRIPTION OF THE PREFERRED EMBODIMENTS

The examples presented herein should not be construed as limiting the scope of the embodiments of this invention, as other equally effective examples are possible and likely. Specific details are set forth in order to provide a thorough understanding of the embodiments and examples described, herein. These examples may be done without the specific details. Other times procedures and methods have not been described in order to avoid obscuring the description.

As used herein GREENEBANK shall mean a computer database platform similar to a bank is available to the address/location through the internet.

As used herein “Cap and Trade Credits” or “Carbon Offset Credits” and variations and derivatives thereof shall have the common meaning as set forth by Congress and compromise credits or debits to a financial instrument or any combination of these, and/or the like. Cap and trade credits or carbon offset credits shall include steps taken by address/location to recycle materials that qualify for cap and trade credits or carbon offset credits.

More particularly, the information below relates to a system of aggregating records from address/location of collected recyclable material to assign cap and trade or carbon offset credits to:

### DESCRIPTION

Field of the invention.

The following disclosure relates to a specific process to create aggregated records by address/location of recyclable materials collected assigning carbon offset credits to those records and providing carbon offset cap and trade certificates to the address/location and a platform for the bid, purchase and sale of carbon offset credits.

Description of related art.

Loyalty award programs such as frequent flyer and incentive award programs were developed by numerous industries to reward customers for repeat business or the amount used. Points may be redeemed or collected and accumulated or a dollar credit amount may be redeemed or collected and accumulated.

While these programs exist in retail businesses or the like, in the recycling either by household or businesses carbon offset cap and trade credits does not exist.

There is need in the recycling industry for a system for aggregating record data by address/location of recyclable materials collected, assigning carbon offset cap and trade carbon credits to those amounts, and providing a platform for bid, purchase and sales of carbon offset credits. In the recycling industry there is also a need for a system and method of providing carbon offset credit incentives to address/location to increase and/or start recycling.

I claim:

1. A method for cross-integrating data collected through patents #20110038703 FILL-A-BOX, WINROWS (patent pending), and STAT-MEDICAMENT-DISPOSAL™ which is a continuation of those patents in part. The disclosures of which are incorporated herein by reference in their entirety. The data from the above referenced patents create an aggregated record of recyclable materials from address/location that meet the criteria for credit under cap and trade, carbon offset rules.

2. A method claimed in 1 that creates a database of recyclable material by address/location.

3. A method claimed in 1 and 2 that provides a database of aggregated records of recyclable material that have been converted to cap and trade, carbon offset credits.

4. A method claimed in 1, 2 and 3 that provides access through a data portal device via interne, establishing access to the aggregated record of recyclable material from address/location enabling address/location to manage and view cap and trade carbon offset credits.

5. A method claimed in 1, 2 and 3 that provides access through a data portal device via interne, establishing access to aggregated records of recyclable material from address/location to trade or sell cap and trade carbon offset credits.

6. A method claimed in 1, 2 and 3 that provides access through a data portal device via interne establishing a method of administering the bid and purchase of cap and trade carbon offset credits by third party vendors.

7. A method claimed in 1, 2 and 3 that provides access through a data portal device via internet for bid, purchase, trade or sell carbon financial instruments.

8. A method claimed in 1, 2 and 3 that provides access through a data portal device via internet, quantitative schedules of direct emission reductions.

9. A method claimed in 1, 2 and 3 that provides access through a data portal device via internet a quantity of carbon stored in biomass, biowaste and soils expressed in metric tons “CO2” equivalents.

10. A method claimed in 1, 2 and 3 that aggregates individual address/location carbon offset cap and trade credits for sale and redemption purposes.

11. A method claimed in 1, 2 and 3 that embodies a method of counting and weighing items by address/location and storing that data in a database program by address/location, then aggregating that data and placing that data either on a carbon offset cap and trade exchange or through a private transaction or sale of household hazardous waste.

12. A method claimed in 1, 2 and 3 that embodies a method of weighing by address/location and storing that data in a database program by address/location, then aggregating that data and placing that data either on a carbon offset cap and trade exchange or through a private transaction or sale of food waste.

13. A method claimed in 1, 2 and 3 that via the internet and a password protected website provides per address/location an accounting of household hazardous waste and food waste collected.

14. A method claimed in 1, 2 and 3 that via the internet and a password protected website provides per address/location an accounting of cap and trade offsets based on the accounting of household hazardous waste and food waste counted and weighed.

15. A method claimed in 1, 2 and 3 that via the internet and a password protected website provides per address/location a program to offer the sale all or a portion of carbon offset credits in the address/location account.

16. A method claimed in 1, 2 and 3 that via the internet and a password protected website provides per address/location accounting of sales of carbon offset credits.

17. A method claimed in 1, 2 and 3 that via the Internet and a password protected website provides per address/location a facility to claim by check or electronic transfer carbon offset credits in the address/location account.

18. A method claimed in 1, 2 and 3 that via the Internet trading of carbon offset credits either through private transactions or via and exchange that have aggregated from the address/location the household hazardous waste and food waste collected and weighed.

19. A method claimed in 1, 2 and 3 that via the internet allows internet transfer, trade or transfer of carbon offset credits between various companies that have related patents Fill-A-Box (patent #20110038703) and Winrows (patent Ser. No. 13/199,870).

20. A method claimed in 1, 2 and 3 that via the internet and a password
